(19) United States
(12) Patent Application Publication
(10) Pub. No.: US 2012/0291337 A1
(43) Pub. Date: Nov. 22, 2012

(54) Bug Housing for Attracting, Monitoring, and Detecting Bugs

(76) Inventor: Maria Curcio, Freehold, NJ (US)

(21) Appl. No.: 13/110,320

(22) Filed: May 18, 2011

(51) Int. Cl. A01M 1/14; A01M 1/10

(52) U.S. Cl. 43/114; 43/123

(57) ABSTRACT

The present invention provides a bug housing for attracting, monitoring and detecting bugs, including bed bugs. The housing 10 includes first and second layers 12 and 14 being of any shape, and being held in a spaced apart configuration by suitable spacing devices, such as corner posts. At least one of the first and second layers 12 and 14 has at least one glue and/or adhesive area 32 layer thereon. The glue and/or adhesive area 32 includes therein lactic acid 40, scents or fragrances 50, hormones, human pheromones 60, and 1-Octen-3-ol for attracting, monitoring and detecting bugs.

### FIELD OF THE INVENTION

The present invention relates to a bug housing having glue, hormones, pheromones, lactic acid, or 1-Octen-3-ol for attracting, monitoring, and detecting bed bugs and other types of bugs.

### BACKGROUND OF THE INVENTION

Bed bugs have become a prevalent menace to homes, businesses, hotels, and public places, and they are difficult to detect and eradicate. Many types of products have been developed for monitoring and detecting bed bugs, but they have not been satisfactory.

For example, U.S. Pat. No. 7,892,528 entitled “Controlling Bedbugs With Synthetic Pheromones And/Or Infrared Radiation” is a patent which discloses a trap which relates to the use of pheromones and/or infrared radiation for attracting bedbugs. The trap also uses a sticky glue surface, which acts as the actual insect trapping mechanism. As shown in FIGS. 13 and 14, the trap uses a toxic bait to control the insect. The trap has a housing (84) with entryways (86) sized to allow an insect such as a bedbug to enter. A pheromone formulation is positioned within the housing (84) by impregnating a substrate (88) such as paper with it. Preferably, the paper also contains a contact toxin. An infrared generator and reflector (90) that emits infrared radiation as discussed above can also be positioned inside the housing (84). Bedbugs are attracted into the housing (84). They then ingest or otherwise come into contact with the toxin, and are thereby controlled. This patent is different from the present invention which employs human pheromones as opposed to animal pheromones, and it is non-toxic.

U.S. Pat. No. 7,591,099 entitled “Bed Bug Monitor” also discloses a trap which relates to the use of pheromones and/or infrared radiation for attracting bedbugs. It also discloses a trap with an adhesive on the bottom of the trap. As shown in FIGS. 1 and 2, the bottom of the bedbug monitor (10) uses a cardboard layer (12) sandwiched between a first glueboard (14) and a second glueboard (16). An adhesive layer (18 and 20) is positioned on each glueboard on the side that contacts the fluted cardboard layer (12). As a result, when bugs crawl into the crevices of the cardboard, they will contact the adhesive layer (18 or 20) and become immobilized. The adhesive layer also serves to secure the glueboards to the cardboard layer. This patent is different from the present invention which employs human pheromones as opposed to animal pheromones, and it is non-toxic.

U.S. patent application Ser. No. 12/769,708 entitled “BedBug Trap” also discloses a trap with an adhesive attached to the bottom surface of the bottom panel of the trap, which is adapted to capture an insect. As shown in FIGS. 1A and 1B, the adhesive is preferably attached to the bottom surface (50) of the first panel, the bottom surfaces (hidden) of the second and third panels (32, 34), and the bottom surface (52) of the fourth panel (36), preferably in the areas at or adjacent the crevices formed between the panels (30,32,34,36) and the bottom support surface (22) or along the entire bottom surfaces. The adhesive (48) may be of any standard type known in the art typically used for catching legs of a small insect like a bedbug.

U.S. Pat. No. 5,271,179 entitled “Insecticidal Compositions And Articles Of Manufacture Containing The Same” also discloses an adhesive trap containing panel walls treated with insecticide. As shown in FIGS. 1 and 2, the interior walls of the trap are treated with appropriate insecticidal compositions like those seen in other insect controlling devices like pest strips, fly papers, tapes, ribbons or sheets.

### OBJECTS OF THE INVENTION

It is an object of the present invention to provide a bug housing for attracting, monitoring, and detecting bugs, including bed bugs, using a novel combination of glue, adhesives, lactic acid, hormones, human pheromones, or 1-Octen-3-ol, and fragrances.

It is an object of the present invention to provide a bug housing which is inexpensive to construct, is easy to use, and is effective in monitoring and detecting bugs, including bed bugs.

It is an object of the present invention to provide a bug housing which is non-toxic, pesticide free, with a pleasant scent, and uses no harmful chemicals.

### SUMMARY OF THE INVENTION

The present invention provides a bug housing for attracting, monitoring and detecting bugs, including bed bugs. The housing 10 includes first and second layers 12 and 14 being of any shape, and being held in a spaced apart configuration by suitable spacing devices, such as corner posts. At least one of the first and second layers 12 and 14 has at least one glue and/or adhesive area 32 layer thereon. The glue and/or adhesive area 32 includes therein lactic acid 40, scents or fragrances 50, hormones, and/or human pheromones 60, and/or 1-Octen-3-ol for attracting and detecting bugs.

### BRIEF DESCRIPTION OF THE DRAWINGS

FIG. 1 is a perspective view of the bug housing of the present invention showing the first embodiment formed of 2 plastic layers which are held in a spaced apart configuration by 4 corner posts;

FIG. 2 is a front view of the bug housing shown in FIG. 1;

FIG. 3 is a side view of the bug housing shown in FIG. 1;

FIG. 4 is a top view of the first plastic layer in the bug housing shown in FIG. 1;

FIG. 5 is a perspective view of the bug housing of the present invention showing the second embodiment formed of 3 plastic layers which are held in a spaced apart configuration by 4 corner posts on each layer;

FIG. 6 is a front view of the bug housing shown in FIG. 5;

FIG. 7 is a side view of the bug housing shown in FIG. 5; and

FIG. 8 is a top view of the first plastic layer in the bug housing shown in FIG. 5,

### DETAILED DESCRIPTION OF THE PREFERRED EMBODIMENT

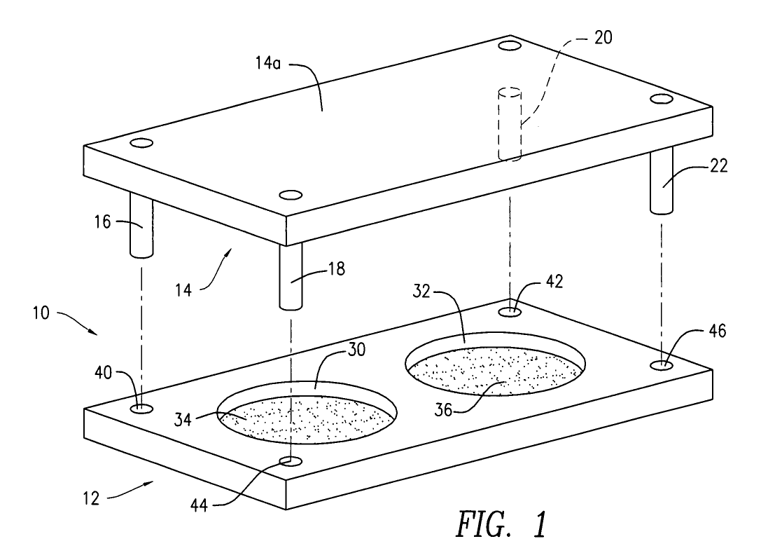

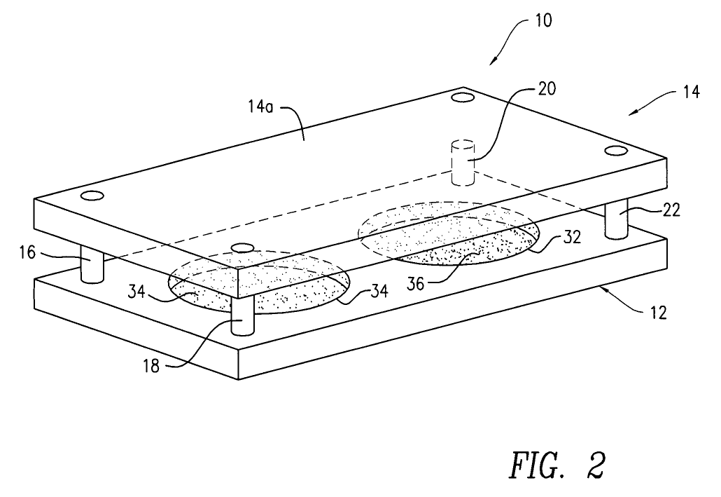

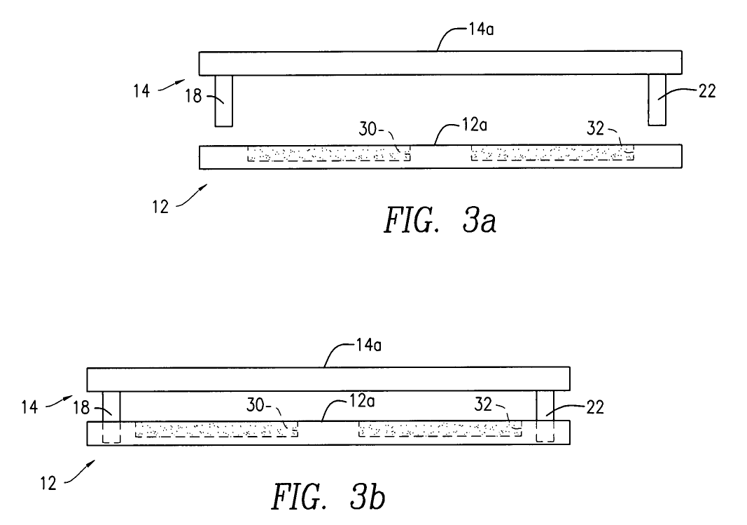

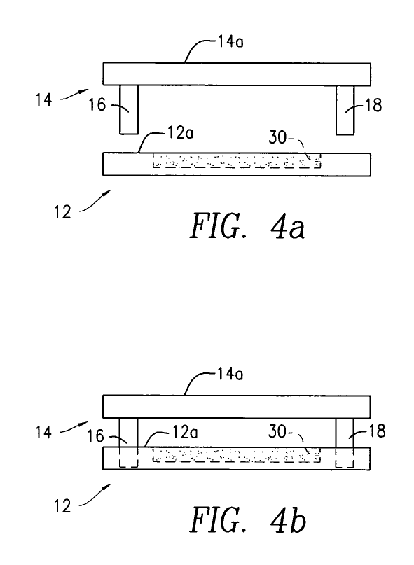

The bug housing 10 is formed of 2 separate plastic layers 12 and 14, which are held in a spaced apart configuration by 4 corner posts 16, 18, 20, and 22, as shown in FIGS. 1 to 4 of the drawings. The number and the placement of the posts may be varied. The housing 10 can be of any size or shape, such as square, rectangular, round, or oval, by way of example only.

A glue and/or adhesive mixture 30 is applied to the upper surface 12a of plastic layer 12 to form glue and/or adhesive areas or patches 32. Hereinafter, “glue” is understood to include all glues and adhesives listed below. Glue patches or glue layers 32 may be placed on any area of surface 12a. For example, rodent adhesive glue may be used, which is sold on the market as a pressure sensitive adhesive glue. In the preferred embodiment, depressions or cutouts 34 and 36 are formed in the upper surface 12a of plastic layer 12 to receive the glue layer 30 in each of the depressions 34 and 36. It should be understood that the number of depressions 34 and 36 can be varied, and the shapes of the depressions 34 and 36 can also be varied to accommodate specific uses. In addition, glue strips or glue tapes may be used to form the glue surface. Further, layers 12 and 14 may be roughened or textured, except in the glue areas, to provide a non-slip surface for the bugs.

Lactic acid 40 is mixed into the glue layer 30 before it is applied to surface 12a. Also, one or more scents or fragrances 50 may be mixed into the glue layer 30 before it is applied to surface 12a.

In addition, human pheromones 60, such as Androstenone or Androstadienone may be added to the glue layer 30. Also, 1-Octen-3-ol may be added to the glue layer 30. It is contained in human sweat and it attracts insects.

The plastic layers 12 and 14 of the housing are preferably formed of a clear, transparent plastic material. The following plastics are examples of clear plastics that may be employed: Acrylic, ABS, Silicone, Polycarbonate, NAS, SAN, SMMA, Polystyrene, K Resin, Polyproylene, Ethylene, PETG, and TPX. If non-clear plastics are used, they are: Polyacetylene (electronically conductive), Polyamides (nylons), and Polyurethanes.

The present invention may employ any plastics that are partially crystalline or amorphous in molecular structure. For example, the following plastics may be used to form the bug housing 10 of the present invention:

### 1) Thermoplastics:

ABS, PMMA, Celluloid, Cellulose acetate, COC, EVA, EVOH, Flouroplastics, Ionomers, LCP, POM, PAN, PA, PAL PAEK, PBD, PB, PBT, PCL, PCTFE, PET, PCT, PC, PHAs, PK, Polyester, PE, PEEK, PEKK, PEI, PES, CPE, PI, PLA, PMP, PPO, PPS, PPA, PP, PS, PSU, PTT, PU, PVA, PVC, PVDC, SAN, SRP, TPI, HTS, PFSA, PPSU, PESU, PARA, HPN, PPC, PEX, UHMWPE, HDPE, HIPS, PC/ABS, UF, MF, PF, PTFE.

### 2) Thermosetting Polymers:

DAP, DAIP, Phenolics, Epoxy resins, Epoxy Polysulphides, Epoxy Silicones, Resorcinol Resins, Polyesters, Polyimides, SMC, BMC, EPDM, SBR, Redux Adhesive.
   Glues or Adhesives to be Mixed with the Lactic Acid 40 and the Scents 50:

Non-reactive glues or adhesives 30 that can be used are:
a. Pressure sensitive;
b. Drying;
c. Contact;
d. Thermoplastic;

Reactive adhesives 30 that can be used are:
e. Multi-part adhesives (polyester resin, polyols, acrylic polymers);
f. One-part adhesives (light curing).

Natural adhesives 30 that can be used are:
g. Vegetable matter;
h. Starch;
i. Natural resins;
j. Animals e.g. casein or animal glue.

Synthetic adhesives 30 that can be used are:
k. Elastomers;
l. Thermoplastics;
m. Emulsions;
n. Thermoset.

Methods of adhering the adhesives 30 are:
o. Anaerobics—synthetic acrylic resins.
p. Cyanoacrylates—special type of acrylic resin.
q. Toughened Acrylics—Two part acrylics adhesive/activator.
r. Epoxies—epoxy resin plus hardener.
s. Polyurethanes—single or two part systems.
t. Silicones—single or two part systems.
u. Phenolics—bond to metals, require heat and pressure.
v. Polyimides—synthetic organic chains.
w. Hot Melts—thermoplastics.
x. Plastisols—require heat.
y. Rubber Adhesives—solutions or latexes.
z. Polyvinyl Acetate (PVA's)—paper, wood, or packaging uses.
aa. Pressure Sensitive Adhesives—tapes or labels, doesn't solidify.

The glues or adhesives 30 can be applied to surface 12a by a number of methods, including but not limited to using glue strips, glue tapes, dots of glue, glue or adhesive brushes or rollers, glue or adhesive films, glue or adhesive pellets, spray guns, applicator guns, or appropriate machinery for applying glues or adhesives to flat surfaces.

Lactic Acid 40 may be added to glue 30. It is food grade (Industrial Grade) 88%, or L+Lactic Acid or L−Lactic Acid, since they are also 80% food grade—see MSDS Sheet for Lactic Acid.

Also, 1-Octen-3-ol referred to as 44 may be used. It is contained in human sweat, and it attracts insects.

Scents or fragrances 50 may be artificial vanilla flavoring (dark, clear and light vanilla) which are added to the glue layer 30, which is also combined with the Lactic Acid 30 in the glue layer. Varying amounts of fragrances 50 may be added to the glue layer 30 depending upon the particular application. For example, a mold has a stronger degree of scent to be used as an air freshener to be placed under the seat in automobiles or homes. Fragrances 50 may include Vanilla, Cherry, Pina Colada and numerous other fragrances or scents. In this manner, the bug housing also provides the dual function of being used as an air freshener, wherever it is placed, such as automobiles, boats, homes, movie theaters, etc.

In addition, glue layer 30 may include therein a human hormone 70 that is found in human skin or sweat, wherein said hormone may be natural or is synthetically derived to attract bugs.

Human pheromones 60, such as Androstenone or Androstadienone, may also be added to glue layer 30.

### Second Embodiment

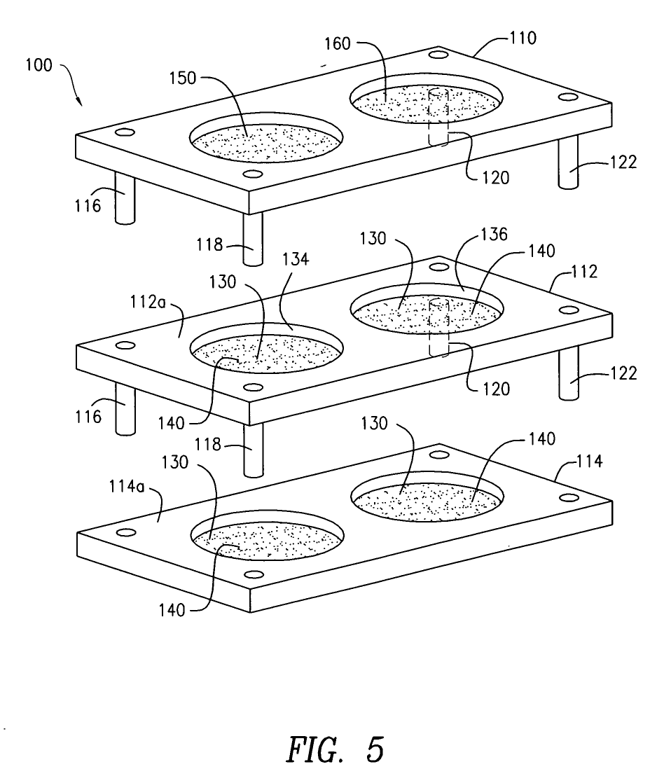

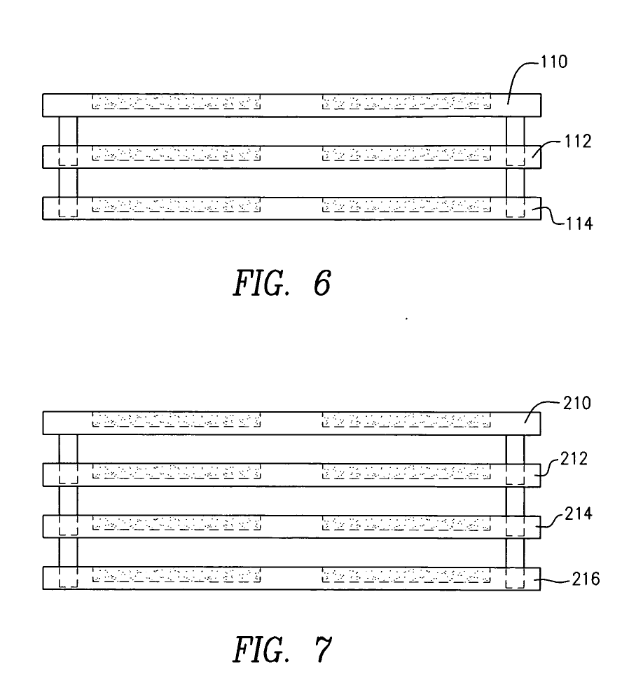

The bug housing 100 is formed of 3 plastic layers 110, 112, and 114, which are held in a spaced apart configuration by 4 corner posts 116, 118, 120, and 122 on each of the plastic layers 110 and 112, as shown in FIGS. 5 to 8 of the drawings. The housing 100 can be of any size or shape, such as square, rectangular, round, or oval, by way of example only.

A glue layer 130 is applied to the upper surface 112a of plastic layer 112 and upper surface 114a of plastic layer 114 to form glue layers 130, on each of the 2 layers. Layers 130 may be placed on any area of surfaces 112a and 114a. In the preferred embodiment, depressions or cutouts 134 and 136 are formed in the upper surfaces 112a and 114a of plastic layers 112 and 114 to receive the glue layer 130 in each of the depressions 134 and 136 on each layer. It should be understood that the number of depressions 134 and 136 can be varied, and the shapes of the depressions 134 and 136 can also be varied to accommodate specific uses.

Lactic acid 140 is mixed into the glue layer 130 before it is applied to the depressions 134 and 136 formed in surfaces 112a and 114a. One or more scents or fragrances 150 are also mixed into the glue layer 130 before it is applied to the depressions 134 and 136 in surfaces 112a and 114a.

Human pheromones or hormones 160, such as Androstenone or Androstadienone may be added to the glue layer 130. Also, 1-Octen-3-ol may be used to attract bugs.

In addition, glue layer 130 may include therein a human hormone 170 that is found in human skin or sweat, wherein said hormone may be natural or is synthetically derived to attract bugs.

In this second embodiment, the plastic layers may be formed of the same plastic materials discussed above. In addition, the glue layer 130 may be the same as discussed above.

### Operation of the Present Invention

The bug housing 10 or 100 of the present invention are placed in any suitable area that may have bugs or bed bugs to be monitored and detected. For example, they can be placed under mattresses or beds, in bedrooms, homes, hotels, businesses, offices, couches, cushions, movie theaters, or other public places. The glue, adhesive, lactic acid, hormones, human pheromones, 1-Octen-3-ol, or scents will attract the bugs, and cause them to be collected in the glue or adhesive areas. The user periodically monitors the bug housing to determine if there are any bugs collected. If so, the user will have to have the location treated, and discard the bed bug trap.

### ADVANTAGES OF THE PRESENT INVENTION

The present invention has provided the advantage of a bug housing for attracting, monitoring and detecting bugs, including bed bugs, using a novel combination of glue, adhesives, lactic acid, hormones, human pheromones, 1-Octen-3-ol and fragrances.

The present invention has provided the advantage of a bug housing which is inexpensive to construct, is easy to use, and is effective in monitoring and detecting bugs, including bed bugs.

The present invention has provided the advantage of a bug housing which is non-toxic, pesticide free, with a pleasant scent, and uses no harmful chemicals.

A latitude of modification, change and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1) A bug housing for attracting and detecting bugs, including bed bugs, comprising:
a) first and second layers 12 and 14 being of any shape being held in a spaced apart configuration by suitable spacing devices;
b) at least one of said first and second layers 12 and 14 having at least one glue layer 32 thereon; and
c) said glue layer 32 including therein lactic acid 40 and scents or fragrances 50 for attracting and detecting bugs.

2) A bug housing in accordance with claim 1, wherein said glue layer 32 further includes one or more human pheromones, namely, Androstenone or Androstadienone.

3) A bug housing in accordance with claim 1, wherein said glue layer 32 further includes 1-Octen-3-ol.

4) A bug housing in accordance with claim 1, wherein said glue layer 32 further includes one or more human pheromones, namely, Androstenone or Androstadienone, and further includes 1-Octen-3-ol.

5) A bug housing in accordance with claim 1, wherein said first and second layers are formed of a clear, transparent plastic material.

6) A bug housing in accordance with claim 1, wherein said first and second layers are formed of a non-transparent plastic material.

7) A bug housing in accordance with claim 1, wherein said first and second layers have a roughened or textured non-slip surface, in the areas where glue is not present.

8) A bug housing in accordance with claim 1, wherein said glue layer 32 includes any of the following types of adhesives: pressure sensitive, drying, contact, thermoplastic, reactive adhesives, natural adhesives, or synthetic adhesives.

9) A bug housing in accordance with claim 1, wherein said scents or fragrances 50 include vanilla flavoring, cherry flavoring, or pina colada flavoring.

10) A bug housing for attracting and detecting bugs, including bed bugs, comprising:
a) first, second, and third layers 112, 114, and 116 being of any shape being held in a spaced apart configuration by suitable spacing devices;
b) at least two of said layers 112, 114, and 116 each having at least one glue layer 132 thereon; and
c) said glue layer 132 including therein lactic acid 140 and scents or fragrances 150 for attracting and detecting bugs.

11) A bug housing in accordance with claim 10, wherein said glue layer 132 includes one or more human pheromones, namely, Androstenone or Androstadienone.

12) A bug housing in accordance with claim 10, wherein said glue layer 132 further includes 1-Octen-3-ol.

13) A bug housing in accordance with claim 10, wherein said glue layer 132 includes one or more human pheromones, namely, Androstenone or Androstadienone, and further includes 1-Octen-3-ol.

14) A bug housing in accordance with claim 10, wherein said first and second layers are formed of a clear, transparent plastic material.

15) A bug housing in accordance with claim 10, wherein said first and second layers are formed of a non-transparent plastic material.

16) A bug housing in accordance with claim 10, wherein said first and second layers have a roughened or textured non-slip surface, in the areas where glue is not present.

17) A bug housing in accordance with claim 10, wherein said glue layer 132 includes any of the following types of adhesives: pressure sensitive, drying, contact, thermoplastic, reactive adhesives, natural adhesives, or synthetic adhesives.

18) A bug housing in accordance with claim 10, wherein said scents or fragrances 150 include vanilla flavoring, cherry flavoring, or pina colada flavoring.

19) A bug housing for attracting and detecting bugs, including bed bugs, comprising:
a) first and second layers 12 and 14 being of any shape being held in a spaced apart configuration by suitable spacing devices;
b) at least one of said first and second layers 12 and 14 having at least one glue layer 32 layer thereon;
c) said glue layer 32 including therein a human hormone that is found in human skin or sweat, wherein said hormone is natural or synthetic; and
d) said glue layer 32 including therein 1-Octen-3-ol.

20) A bug housing in accordance with claim 19, wherein said glue layer 32 further includes one or more human pheromones, namely, Androstenone or Androstadienone.
